(19) United States
(12) Patent Application Publication
(10) Pub. No.: US 2009/0026978 A1
(43) Pub. Date: Jan. 29, 2009

(54) SYSTEM AND METHOD FOR LIGHT SOURCE IDENTIFICATION

(75) Inventor: Shane Robinson, Gibsons (CA)

Correspondence Address: PHILIPS INTELLECTUAL PROPERTY & STANDARDS, 3 BURLINGTON WOODS DRIVE, BURLINGTON, MA, 01803, US

(73) Assignee: TIR TECHNOLOGY LP, Burnaby, BC (CA)

(21) Appl. No.: 12/279,419

(22) PCT Filed: Feb. 22, 2007
(86) PCT No.: PCT/CA2007/000270

§ 371 Date: Aug. 14, 2008

Related U.S. Application Data
(60) Provisional application No. 60/775,792, filed on Feb. 23, 2006.

(51) Int. Cl. H05B 39/04; H05B 37/00

(52) U.S. Cl. 315/294

(57) ABSTRACT

A light source is configured to send a beacon signal representative of the unique identifier thereof, on command, constantly or at a predetermined interval. The beacon signal is integrated into the light emitted by the light source, wherein the integration of the beacon signal is performed in a manner that visible flicker of the resultant light is imperceptible. A remote detection unit is configured to receive the light and extract the beacon signal therefrom. In this manner the remote detection device is capable of wirelessly determining the unique identifier of a light source. The collected unique identifier of the light source can subsequently be provided to a controller associated with the light source, thereby providing individual control of the light source by the controller. Through the use of electronic data transfer from the remote detection unit to the controller, the provision of the one or more unique identifiers to the controller can be enabled in an efficient and accurate manner.

### FIELD OF THE INVENTION

The present invention pertains to lighting systems and in particular to identification of light sources associated with lighting systems.

### BACKGROUND

The installation and set-up of a lighting system with one or more independently controllable light sources can be a cumbersome procedure. Each light source must be individually addressable if it is desired to control the operating conditions of the light sources independently. Observation of a change in operating conditions of each light source through identification, addressing, and control of that light source can be achieved in various different ways including the initial identification and address allocation during installation.

In addition to being a cumbersome procedure, the installation and set-up of a lighting system with one or more independently controllable light sources can also be an error prone procedure. This is due in part because of the menial but required task of assigning a unique identifier to each light source. A unique identifier is required to be able to communicate with a desired light source and to control that light source when generating and sending control commands for it. Furthermore, it can be a time consuming and error prone task to manually set-up or program a control system, with for example these unique identifiers which can provide a means for independently controlling the one or more light sources of the lighting system.

U.S. Pat. Nos. 6,300,727 and 6,169,377 describe a remotely controllable and programmable power control unit for controlling and programming the state and power level, including special functions, of one or more electrical devices including electric lamps. The system includes a remote transmitter unit and power control unit adapted to receive control signals from the remote transmitter unit. Both the remote transmitter unit and the power control unit include a power selection actuator for selecting a desired power level between a minimum power level and a maximum power level, and control switches for generating control signals representative of programmed power levels of one or more power scenes and special functions. In response to an input from a user, either directly or remotely, the one or more devices of the one or more power scenes can be controlled between an ON or OFF state, to a desired programmed preset power level, or to a maximum power level. However, this disclosure does not address the initial wireless identification of the devices.

U.S. Pat. No. 6,426,599 describes an apparatus for generating electromagnetic radiation in which the radiation has both a first and second utility. The electromagnetic radiation is modulated to produce electronically detectable variations to achieve the second utility, the variations not affecting the first utility. As disclosed, the electromagnetic radiation can be visible light, wherein the first utility is illumination and the second utility is the transmission of data. Any variations in the visible light resulting from the data transmission can be imperceptible by a human eye regardless of the nature of the data being transmitted. However, this disclosure does not address the initial wireless identification of the devices.

U.S. Pat. No. 6,680,586 describes a lighting control system that includes a plurality of light modules which each contain a light set with at least one light source and at least one switch for switching the light source ON and OFF. The light module also contains a driving circuit which has at least one switch driver for driving the switch of the light set, and a first transceiver for wirelessly receiving control signals for the light set. The control system also includes a main console, which has a signal generator for generating the control signals that control the light set, and a controller electrically connected to the signal generator for receiving the control signals. The controller has a second transceiver for wirelessly sending control signals received from the signal generator to the first transceiver of the driving circuit so as to control the light set. However, this disclosure does not address the initial wireless identification of the devices.

Therefore, there is a need for a system and method that can improve and simplify the installation and set-up procedure of a lighting system comprising one or more light sources.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a system and method for light source identification. In accordance with an aspect of the present invention, there is provided a system for light source identification, said system comprising: one or more light sources, each light source configured to emit light and further configured to integrate a beacon signal into the light, wherein the beacon signal of a specific light source includes a unique identifier of the specific light source; and a remote detection unit including one or more optical sensors, the remote detection unit configured to detect light emitted by the one or more light sources, the remote detection unit further configured to extract the beacon signal from the light and to determine the unique identifier, thereby identifying light source.

In accordance with another aspect of the invention, there is provided a method for light source identification, said method comprising the steps of: integrating a beacon signal into light emitted by a light source, the beacon signal including a unique identifier of the light source; emitting the light by the light source; detecting the light by a remote detection control unit; and extracting the beacon signal from the light and determining the unique identifier of the light source; thereby identifying the light source.

### BRIEF DESCRIPTION OF THE FIGURES

FIG. 1 illustrates a system for light source identification according to one embodiment of the present invention.

FIG. 2 illustrates a system for light source identification according to one embodiment of the present invention wherein a wired network is used for communicating to the lighting system from a control interface.

FIG. 3 illustrates a system for light source identification according to another embodiment of the present invention wherein a wireless network is used for communicating to the lighting system from a control interface.

FIG. 4 illustrates a system for light source identification according to one embodiment of the present invention wherein there is no existing network present and communication from the remote detection unit to the lighting system is provided by a wireless communication mechanism.

FIG. 5 illustrates a remote detection unit according to one embodiment of the present invention.

### DETAILED DESCRIPTION OF THE INVENTION

### Definitions

The term “light source” is used to define any device or collection of devices that emit radiation in a region or combination of regions of the electromagnetic spectrum.

The term “light-emitting element” is used to define any device that emits radiation in a region or combination of regions of the electromagnetic spectrum for example, the visible region, infrared and/or ultraviolet region, when activated by applying a potential difference across it or passing a current through it, for example. Therefore a light-emitting element can have monochromatic, quasi-monochromatic, polychromatic or broadband spectral emission characteristics. Examples of light-emitting elements include semiconductor, organic, or polymer/polymeric light-emitting diodes, optically pumped phosphor coated light-emitting diodes, optically pumped nano-crystal light-emitting diodes or other similar devices as would be readily understood by a worker skilled in the art. Furthermore, the term light-emitting element is used to define the specific device that emits the radiation, for example a LED die, and can equally be used to define a combination of the specific device that emits the radiation together with a housing or package within which the specific device or devices are placed.

The term “light” is used to define electromagnetic radiation of a particular frequency or range of frequencies in a region of the electromagnetic spectrum, for example, visible, infrared or ultraviolet regions, or a combination of regions of the electromagnetic spectrum.

As used herein, the term “about” refers to a +/−10% variation from the nominal value. It is to be understood that such a variation is always included in any given value provided herein, whether or not it is specifically referred to.

Unless defined otherwise, all technical and scientific terms used herein have the same meaning as commonly understood by one of ordinary skill in the art to which this invention belongs.

The present invention provides a system and method for wireless identification of one or more light sources in a lighting system. The wireless identification of a light source can provide a means for improving accuracy and speed of installation of lighting systems that comprise a plurality of light sources. The identification of a light source can be provided by, for example, a unique identifier, which can be input into a controller of the lighting system, thereby providing the controller with the ability to uniquely identify a light source enabling possible individual control of that light source.

According to the present invention, a light source is configured to send a beacon signal representative of the unique identifier thereof, on command, constantly, randomly or at a predetermined time interval. The beacon signal is integrated into the light emitted by the light source, wherein the integration of the beacon signal is performed in a manner that visible flicker of the resultant light is imperceptible. A remote detection unit is configured to receive the light and extract the beacon signal therefrom. In this manner the remote detection device is capable of wirelessly determining the unique identifier of the light source from which the beacon signal was received. The unique identifier of the light source can subsequently be provided to a controller associated with the light source, thereby enabling individual control of the light source by the controller. Through the use of electronic data transfer from the remote detection unit to the controller, for example via a control interface, the provision of the one or more unique identifiers to the controller can be enabled in an efficient and accurate manner.

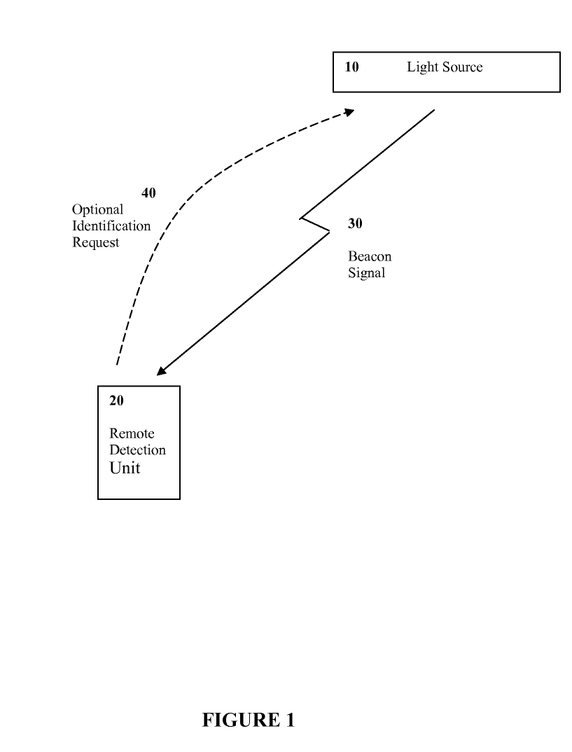

FIG. 1 illustrates one embodiment of the present invention, wherein the light source 10 emits a beacon signal 30 which is integrated into the light emitted thereby. The light is detected by the remote detection unit 20, which extracts the beacon signal therefrom thereby enabling the identification of the light source 10.

In one embodiment, the remote detection unit 20 can send an identification request 40, which can prompt the light source 10 to integrate the beacon signal into the light emitted thereby.

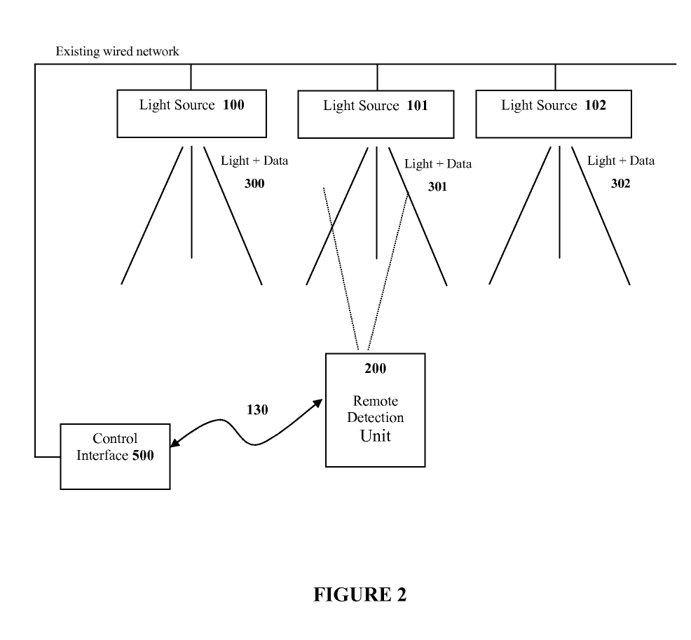

FIG. 2 illustrates one embodiment of the present invention, wherein the light sources 100, 101, and 102 emit identifying beacon signals 300, 301, and 302 which are integrated into the light emitted by each respective light source. The remote detection unit 200 can be aimed at one light source, for example light source 101, in order to selectively collect light emitted thereby, and the light emitted from this light source can be detected by the remote detection unit 200, which subsequently extracts the beacon signal therefrom, thereby enabling the identification of that light source.

In one embodiment, the remote detection unit 200 can be connected to a control interface 500 of the lighting system via a wired or wireless connection. FIG. 2 illustrates this connection as a wired connection 130. The remote detection unit can communicate through the control interface 500 to the lighting system, and the control interface 500 can communicate with the lighting system via a wired network. For example, a request can be sent across the network for all light sources to transmit their respective unique identifier by integrating it into a beacon signal. Upon receipt of the beacon signal and extraction of the unique identifier, the respective light source can be controlled using the remote detection unit 200 or the control interface 500.

In one embodiment of the present invention, a wired connection exists between the control interface and the remote detection unit and may be, for example, a coaxial cable, fibre cable, Ethernet cable or other wired communication network, as would be readily understood by a worker skilled in the art. In another embodiment, a wireless connection is present between the control interface and the remote detection unit, and may be, for example, based on IEEE 802.11 protocol, Bluetooth, RF wireless or other wireless connection, as would be readily understood by a worker skilled in the art.

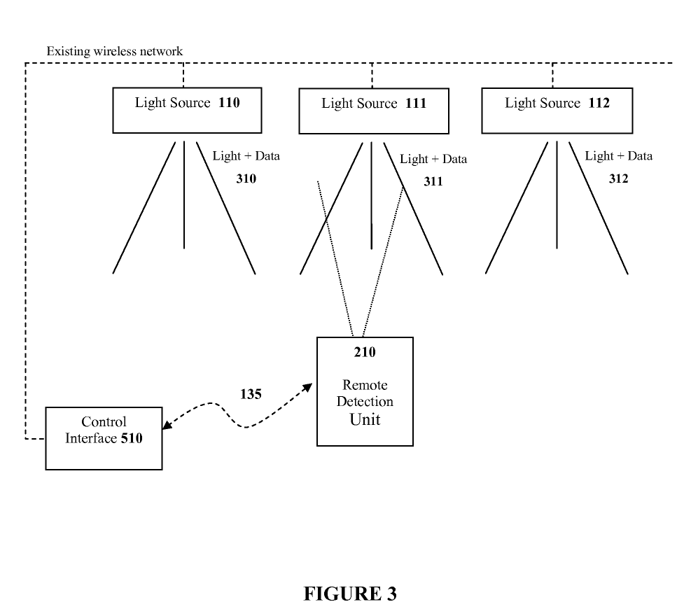

FIG. 3 illustrates one embodiment of the present invention, wherein the wired or wireless connection 130 between the remote detection unit 210 and the control interface 510 of the lighting system is provided by a wireless connection 135, for example based on IEEE 802.11 protocol, Bluetooth, RF wireless or other wireless connection, as would be readily understood by a worker skilled in the art. The control interface 510 can also communicate with the light sources through a wireless connection. This configuration of the communication network between the remote detection unit and the lighting system via the control interface can provide an installer with freedom to move around the room without restriction from a connection cable. In one embodiment, the lighting system comprises a plurality of wirelessly interconnected light sources, thereby allowing the remote detection unit 210 to control lights sources 110, 111, and 112 via a wireless communication network.

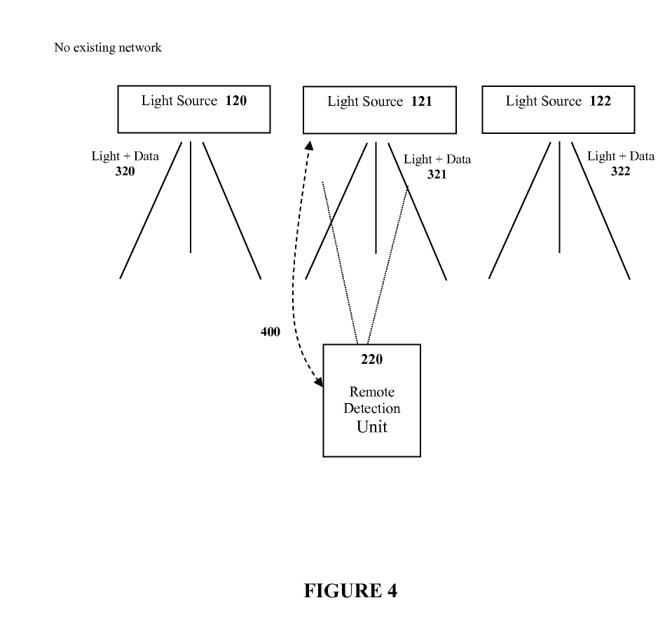

FIG. 4 illustrates one embodiment of the present invention, wherein the lighting system comprises a plurality of light sources, wherein the light sources operate autonomously. In this configuration, communication 400 between the remote detection unit 220 and each of the light sources 120, 121, and 122 can be provided by wireless communication, for example RF wireless, infrared, based on IEEE 802.11 protocol, Bluetooth or other wireless communication, as would be readily understood by a worker skilled in the art. Upon receipt of a beacon signal from one or more of the light sources and subsequent extraction of the unique identifier therefrom for each of the one or more light sources, the remote detection unit 220 can directly control a given light source or group of light sources.

### Light Source

In general, a light source comprises one or more light emitting elements operatively mounted within their respective or shared packages on a substrate or the like. A shared and/or respective driving means, for example a driver or the like, may be operatively coupled to the one or more light-emitting elements and to a power source for driving the light-emitting elements. Optional control means, such as a micro-controller or the like, may also be included and operatively coupled to the driving means in order to control, and possibly optimise, an output of the light-emitting elements and/or a combined output of the light source. Various driving and optional control means may be considered herein without departing from the general scope and nature of the present disclosure.

The light source is configured to emit light in order to generate a desired level of illumination and further configured to integrate a beacon signal into the emitted light, wherein the beacon signal is representative of the unique identifier of the light source. The unique identifier provides a means for individual control of a light source by a controller, for example. The light source can further be configured to send the beacon signal at predetermined intervals, continuously, randomly, on command or a combination thereof.

For example, some light sources such as light-emitting elements exhibit transient light emission characteristics which can rapidly follow drive current changes and can be operated in a sequence of ON and OFF conditions without causing luminous flux output or colour variations that would be perceivable or would cause discomfort to the human eye because the human visual system's sensitivity to these fluctuations decreases rapidly when the fluctuation frequency increases beyond certain limits, for example about 60 Hz. In consequence, luminous flux output and colour control can be accomplished by pulse width modulation (PWM) or pulse code modulation (PCM) techniques as is well known in the art. As a result, some light sources can be switched without causing perceivable flicker and the operation thereof can also be modulated to transmit data at a reasonable data transfer rate within the emitted light. Moreover, this modulation can be possible without perceivably affecting the total luminous flux output or colour of the light emitted by the light source. In consequence, the light emitted by the light source can provide two utilities, one for lighting and one for data transfer.

In one embodiment of the present invention, in order to transmit data the light emitted by a light source can be modulated using Amplitude Modulation (AM), Frequency Modulation (FM), Phase Modulation (PM), pulse code modulation (PCM) or other modulation technique as would be readily understood by a worker skilled in the art.

In one embodiment of the present invention, the light source is configured to send the beacon signal upon request. In this configuration, the light source upon receipt of a request by a remote detection unit, for example an “identify yourself” request, the light source integrates the beacon signal into the light being emitted thereby. The light source can be configured to receive and process this request in a plurality of manners as would be known to a worker skilled in the art. In this embodiment of the present invention, the remote detection unit is configured as a transmitter and a receiver, namely a transceiver, for transmission of the request and detection of the light having the integrated beacon signal.

In another embodiment, the beacon signal is integrated into the emitted light at predetermined intervals, for example about every 10 seconds, 30 seconds or other predetermined time period. In this embodiment, the remote detection unit can be configured as a receiver only, wherein it is configured to receive the automatically transmitted beacon signal.

In one embodiment, when the light source is configured to emit light that is a blend of multiple colours of light, for example a light source configured as a red, green, blue (RGB) or red, green blue, amber (RGBA) light source, the beacon signal can be integrated into the light emitted by a single colour. For example, the beacon signal can be integrated into the light emitted by one or more of the red light-emitting elements within the light source.

In another embodiment, the beacon signal can be integrated into the light emitted by one or more of the light-emitting elements of a light source. The number of light-emitting elements configured to transmit the beacon signal can be determined based on the distance at which detection of the beacon signal is desired or the configuration of the light source, for example whether the light source is configured for individual control or group control of the light-emitting elements from which it is formed.

In one embodiment, wherein the light source comprises one or more secondary emission light-emitting elements, for example phosphor coated light-emitting elements or other optically pumped light-emitting elements, the beacon signal can be integrated into the initial light emitted by the one or more light-emitting elements. In this embodiment, the beacon signal can be integrated into light that is outside of the visible spectrum for example, ultraviolet light or light in another range of the electromagnetic spectrum.

In one embodiment, the unique identifier and other light source characteristics can be pre-programmed as factory settings, for example, during manufacture of the light source. In another embodiment, the default settings of each light source can be overridden and configured to custom settings without permanently loosing the factory settings, thereby providing a means for resetting the light source to original factory settings, if desired.

In one embodiment of the present invention, the beacon signal is an encoded signal. An encoded beacon signal can provide a means for added security of the transmitted information. The encoding of the beacon signal can be performed using one or more of a number of encoding techniques, including linear frequency modulation, binary phase shift keying or the like as would be readily understood by a worker skilled in the art.

### Remote Detection Unit

The remote detection unit is configured to receive the light emitted by a light source and subsequently extract the beacon signal therefrom, thereby identifying the light source. The remote detection unit comprises one or more optical sensors that can detect the light emitted by the light source.

An optical sensor of the remote detection unit can be selected from a variety of devices capable of collecting light, and subsequently transforming that optical signal into an electrical current representative of the detected light. For example the optical sensor can be a photodetector, photodiode, light-emitting element or other device capable of detecting light as would be known to a worker skilled in the art.

In one embodiment of the present invention, an optical filter can be optically coupled to an optical sensor thereby providing a means for filtering a portion of the light emitted by the light source. For example, when the beacon signal is integrated into the light of a particular wavelength or range of wavelengths, for instance when the beacon signal is integrated into light emitted by a particular colour of one or more light-emitting elements of the light source, the optical filter can be configured to substantially isolate that particular wavelength or range of wavelengths. In this configuration, the optical sensor can be configured to be responsive to the desired frequency or range of frequencies or can be a broadband optical sensor or a narrowband optical sensor.

In another embodiment of the present invention, an optical sensor can be configured as a narrow band optical sensor which is sensitive to the desired wavelength or range of wavelengths of light in which the beacon signal is integrated.

In one embodiment of the present invention, the remote detection unit is configured as a transceiver, for example when a request for light source identification is required prior to the light source integrating a beacon signal into the light emitted thereby. The transmission of the request for identification of the light source can be transmitted by the remote detection unit to the light source using for example a wired connection or wireless connection, wherein suitable connections can be coaxial cable, fibre optic, Ethernet, RF wireless, optical, optical, Bluetooth, based on IEEE 802.11 protocol or the like as known by someone skilled in the art.

In another embodiment, the remote detection unit is configured as a receiver only, for example when the beacon signal is continuously, periodically or randomly integrated into the light emitted by the light source. In this configuration of the light source, a unique identifier can then be read from the remote detection unit and manually entered into a control system.

In one embodiment of the present invention, the remote detection unit comprises one or more optical elements that provide a means for collection of the light emitted by the light source. The one or more optical elements can provide a means for one or more of collection, collimation, focusing and redirection of the light towards an optical sensor. For example, the one or more optical elements can be reflective, refractive or have another optical property or combination of properties which are configured to provide the desired manipulation of the light emitted by a light source.

In one embodiment, the one or more optical elements are configured to provide a means for selectively collecting light emitted by a particular light source. In this manner a desired light source can be identified, for example. In one embodiment a remote detection unit can further comprise a sight, for example a laser sight, which can provide a user of the remote detection unit with a visual queue for the alignment of the one or more optical elements with a particular light source, thereby enabling detection of light emitted by that light source.

In one embodiment, the remote detection unit is configured to access a controller, for example via a control interface that controls the light source being identified. In this manner the unique identifier of a particular light source can be transmitted to the controller, thereby providing the controller with the ability to independently control the identified light source. The remote detection unit can transmit this information to the controller in a wireless or wired manner. This transmitted information can optionally be encoded in order in provide a desired level of security.

In one embodiment of the present invention, the remote detection unit comprises a user interface which can provide a means for a user to initiate the process of identification of one or more light sources. For example, by pressing and releasing or holding a certain button on the user interface of the remote detection unit, while pointing the remote detection unit at a desired light source, the process of light source identification can be initiated. Furthermore, the remote detection unit can be configured to provide an acoustic, visual or tactile response indicating that the beacon signal of a selected light source has been successfully completed.

The remote detection unit can comprise a processor, microprocessor or other computing means that provides a means for the extraction of the beacon signal from the light emitted by a light source. The process of extraction of the beacon signal can be dependent on the method by which the beacon signal is integrated into the light. For example, extraction may comprise isolation of the beacon signal or may further require decoding of the beacon signal if the beacon signal is encoded prior to integration into the light. In one embodiment, when the beacon signal is in an encoded format, the remote detection unit can provide the encoded beacon signal to a controller for subsequent decoding thereof in order to determine the unique identifier of a light source.

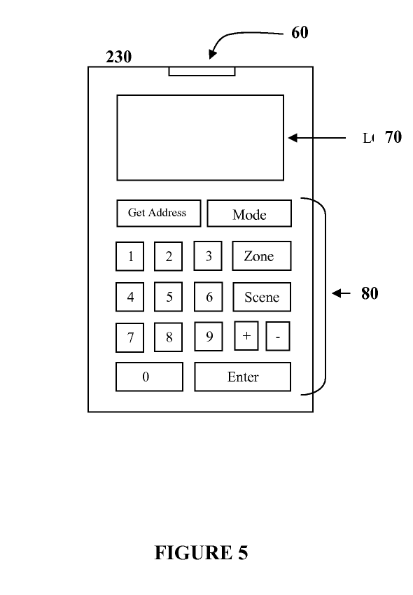

FIG. 5 shows one embodiment of the present invention, wherein the unique identifier is retrieved for a given light source by the remote detection unit 230 through the light sensor 60. The remote detection unit 230 can select certain parameters for that light source through the use of the control buttons 80. The remote detection unit 230 can control which lighting zone the light source belongs to or the brightness of the light source for a given lighting request, for example. Once this information is entered, the control interface may no longer require an address for each light source but may be able to address the light source by zone and can request a certain lighting request or dimming level, for example. An interface screen 70, for example an LCD screen, can be used to display information entered in by control buttons 80 or display unique identifier information as it is retrieved from the light source, for example.

In another embodiment of the present invention, the remote detection unit can be provided with minimal computational power, wherein the majority of the control for adjusting the setup of the light sources can be integrated within the control interface to which the remote detection unit can be connected. In this embodiment, the remote detection unit may solely be used to retrieve the unique identifier of a specific light source, wherein the control interface upon receipt thereof, can proceed with the assignment of lighting zones and other information to that specific light source.

In another embodiment of the present invention, once the remote detection unit has retrieved a unique identifier for a given light source, the remote detection unit can be configured to issue a new unique identifier to the light source. In this manner, a controller can be preconfigured with light source control data which is defined relative to the new unique identifier and upon reassignment of the unique identifier of the light source; the controller can control the light source. In this embodiment, the remote detection unit does not require connection with the controller in order to download the collected unique identifier.

A remote detection unit can take on a number of configurations, wherein each configuration can require a particular level of computational functionality of the remote detection unit in order that the desired functionality of the remote detection unit is enabled, and a worker skilled in the art would readily understand the level of operational functionality required of a remote detection unit for a particular configuration thereof.

It is obvious that the foregoing embodiments of the invention are exemplary and can be varied in many ways. Such present or future variations are not to be regarded as a departure from the spirit and scope of the invention, and all such modifications as would be obvious to one skilled in the art are intended to be included within the scope of the following claims.

1. A system for light source identification and control, said system comprising:
a) a lighting network comprising a plurality of light sources, at least one light source of the plurality of light sources being configured to emit light having a beacon signal integrated into the light, wherein the beacon signal includes a unique identifier of the at least one light source; and
b) a remote detection unit including one or more optical sensors, the remote detection unit being configured to:
i) detect light emitted by plurality of light sources, and
ii) extract the beacon signal from the light and to determine the unique identifier, thereby identifying the at least one light source; and
iii) communicate with the at least one light source on the lighting network using the unique identifier.

2. The system according to claim 1, wherein the the at least one light source is configured to integrate the beacon signal into the light constantly, randomly, or at predetermined time intervals.

3. The system according to claim 1, wherein the remote detection unit is configured to send an identification command to the at least one light source instructing the at least one light source to integrate the beacon signal into the light.

4. The system according to claim 1, wherein the at least one light source is controlled by a control interface and wherein the remote detection unit is operatively coupled to the control interface via a wired connection or a wireless connection.

5. The system according to claim 1, wherein the at least one light source is controlled using pulse width modulation or pulse code modulation.

6. (canceled)

7. The system according to claim 1, wherein the at least one light source comprises a plurality of light-emitting elements of different colors and wherein at least one light source integrates the beacon signal into the light emitted by a light-emitting element of a particular color.

8. (canceled)

9. (canceled)

10. (canceled)

11. The system according to claim 1, wherein the one or more optical sensors are narrowband optical sensors or broadband optical sensors.

12. The system according to claim 1, wherein one of the one or more optical sensors are optically coupled to an optical filter.

13. The system according to claim 1, wherein the one or more optical sensors are selected from the group comprising photodetector, photodiode and light-emitting element.

14. The system according to claim 1, wherein the remote detection unit is a transceiver.

15. The system according to claim 1, wherein one or more optical elements are optically coupled to one or more of the optical sensors.

16. The system according to claim 15, wherein the one or more optical elements are configured to manipulate light towards the one or more optical sensors.

17. The system according to claim 1, wherein the beacon signal is an encoded beacon signal.

18. A method for identification and control of a light source on a lighting network, said method comprising the steps of:
a) integrating a beacon signal into light emitted by a light source, the beacon signal including a unique identifier of the light source;
b) emitting the light by the light source;
c) detecting the light by a remote detection unit;
d) extracting the beacon signal from the light and determining the unique identifier of the light source; thereby identifying the light source; and
e) communicating with the light source on the lighting network using the unique identifier.

19. The method according to claim 18, wherein the beacon signal is an encoded beacon signal.

20. The method according to claim 18, wherein prior to integrating, the remote detection unit sends a command for light source identification.

21. The method according to claim 18, wherein integrating the beacon signal is performed randomly or periodically or constantly.

22. The system of claim 1, wherein the remote detection unit is further configured to address the light source and control at least one parameter of the light emitted by the light source.

23. The method of claim 18, wherein the step of communicating with the light source on the lighting network includes addressing the light source and controlling at least one parameter of the light emitted by the light source.
